(19) United States
(12) Patent Application Publication
(10) Pub. No.: US 2021/0099442 A1
(43) Pub. Date: Apr. 1, 2021

(54) SYSTEM AND METHOD FOR DETECTING FALSE AUTHENTICATION FROM A DEVICE CONNECTED TO A NETWORK

(71) Applicant: Wipro Limited, Bangalore (IN)

(72) Inventors: Venkata Subramanian JAYARAMAN, Chennai (IN); Sumithra SUNDARESAN, Bentonville, AR (US); Shashi KUMAR, Bentonville, AR (US)

(21) Appl. No.: 16/695,361

(22) Filed: Nov. 26, 2019

(30) Foreign Application Priority Data
Sep. 27, 2019 (IN) 201941039217

(51) Int. Cl. H04L 29/06; G06N 20/00

(52) U.S. Cl. CPC H04L 63/0861; G06N 20/00; H04L 63/107

(57) ABSTRACT

The present invention relates to a method of detecting false authentication of a user from a device connected to a network. The method includes receiving one or more parameters associated with the user while the user is logging in to at least one application in the device. Further, a score is generated by associating a binary value to the one or more parameters. Furthermore, reference parameters of the user is retrieved from a database and compared with the one or more parameters. Upon successful validation, the user may be allowed to access the device. Upon unsuccessful validation, one or more queries may be provided to the user. Based on a response received from the user, a false authentication of the user is determined and the user is denied access to the at least one application.

### TECHNICAL FIELD

The present disclosure relates to the field of network security. Particularly, but not exclusively, the present disclosure relates to a method of detecting false authentication of a user from a device connected to the network.

### BACKGROUND

With the increase in networking, devices connecting to a network is increasing at a rapid pace, thereby increasing the vulnerability of the network. A security breach in the device is the easiest way to penetrate the network and control or corrupt other devices connected to the network. For example, a malware may be induced into the network within fraction of seconds after a user logs into the network from an unsecure device such as a laptop or a phone. The existing systems provide multiple levels of security for example, user authentication, biometric authentication and the like to prevent the security breach in the devices. A false authentication may occur where the device incorrectly accepts a biometric sample as a correct match of the user and provides access to the user, thereby providing access to the network.

The existing techniques lack the ability to detect a false authentication of a user during the login. Further, the existing techniques do not provide a solution for securing the network after the false authentication.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Additional features and advantages are realized through the techniques of the present disclosure. Other embodiments and aspects of the disclosure are described in detail herein and are considered a part of the claimed disclosure.

Disclosed herein is a method of detecting false authentication of a user from a device connected to a network. The method includes receiving one or more parameters associated with the user while the user is logging in to at least one application among a plurality of applications in the device. Further, the method includes generating a score by associating a binary value to the one or more parameters, wherein the score is indicative of a priority index associated with the user. Furthermore, the method includes retrieving reference parameters of the user from a database based on the priority index. Subsequently, the method includes comparing the one or more parameters with the reference parameters for validating the one or more parameters. Upon successful validation, the method includes allowing the user to access the at least one application. Upon unsuccessful validation, the method includes providing one or more queries to the user to determine a false authentication of the user based on a response received from the user for the one or more queries and the user is denied access to the at least one application.

Embodiments of the present disclosure discloses an authentication server, for detecting false authentication of a user from a device connected to a network. The authentication server includes a processor and a memory communicatively coupled to the processor, where the memory stores the processor executable instructions, which, on execution, causes the processor to receive one or more parameters associated with the user while the user is logging in to at least one application among a plurality of applications in the device connected to the network. Further, the processor is configured to generate a score by associating a binary value to the one or more parameters, wherein the score is indicative of a priority index associated with the user. Furthermore, the processor is configured to retrieve reference parameters of the user from a database based on the priority index. Subsequently, the processor is configured to compare the one or more parameters with the reference parameters for validating the one or more parameters. Upon successful validation, the processor is configured to allow the user to access the at least one application. Upon unsuccessful validation, the processor is configured to provide one or more queries to the user. Finally, the processor is configured to determine a false authentication of the user based on a response received from the user for the one or more queries, where the user is denied access to the at least one application.

Embodiments of the present disclosure discloses a non-transitory computer readable medium including instructions stored thereon that when processed by at least one processor cause a device to perform operations including determining, based on a current position of the AV in a global path, an angular velocity and curvature required for the AV to reach a safe parking space towards an edge of a road upon detecting non-working of at least one primary sensor among a plurality of primary sensors associated with the AV. Further, detecting, one or more obstacles proximal to the AV using one or more secondary sensors attached to the AV while navigating the AV along determined curvature. Finally, based on detecting the one or more obstacles proximal to the AV, performing at least one of navigating the AV in a track by maintaining a safe distance from the one or more obstacles using remaining primary sensors among the plurality of primary sensors upon detecting presence of the one or more obstacles proximal to the AV in the determined curvature and navigating the AV along the determined curvature at determined angular velocity using the remaining primary sensors among the plurality of primary sensors and the one or more secondary sensors upon detecting absence of the one or more obstacles proximal to the AV in the determined curvature to reach the safe parking space towards the edge of the road.

The foregoing summary is illustrative only and is not intended to be in any way limiting. In addition to the illustrative aspects, embodiments, and features described above, further aspects, embodiments, and features may become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1 shows an exemplary environment for detecting false authentication of a user from a device connected to a network, in accordance with some embodiments of the present disclosure;

FIG. 2 shows a detailed block diagram of an authentication server, in accordance with some embodiments of the present disclosure;

FIG. 3 shows a flowchart illustrating method steps for detecting false authentication, in accordance with some embodiment of the present disclosure;

FIG. 4 shows an exemplary table illustrating a generated score, in accordance with some embodiments of the present disclosure;

FIG. 5 shows an exemplary table containing reference parameters stored in a database, in accordance with some embodiments of the present disclosure;

FIG. 6A shows an exemplary successful validation of a user using Artificial Intelligence (AI) based learning algorithm, in accordance with some embodiments of the present disclosure;

FIG. 6B is an exemplary unsuccessful validation of a user using Artificial Intelligence (AI) based learning algorithm, in accordance with some embodiments of the present disclosure;

FIG. 7 shows an exemplary computer system for detecting false authentication of a user from a device connected to a network, in accordance with some embodiments of the present disclosure.

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and may be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “includes” “comprising”, “including” or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” or “includes . . . a” does not, without more constraints, preclude the existence of other elements or additional elements in the system or apparatus.

The present disclosure describes a method for detecting false authentication of a user from a device connected to a network. An authentication server receives one or more parameters associated with the user while the user is logging in to at least one application among a plurality of applications in the device connected to the network. Further, a score is generated based on number of the one or more parameters received from the user, where the score is indicative of a priority index associated with the user. The one or more parameters are compared with Furthermore, reference parameters of the user are retrieved from a database based on the priority index and the one or more parameters are compared with the reference parameters for validating the one or more parameters. Upon successful validation of the one or more parameters, the user is allowed to access the at least one application. Upon unsuccessful validation, the authentication server provides one or more queries to the user. Based on a response received from the user for the one or more queries, the false authentication of the user is determined, and the user is denied access to the at least one application in the device connected to the network.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

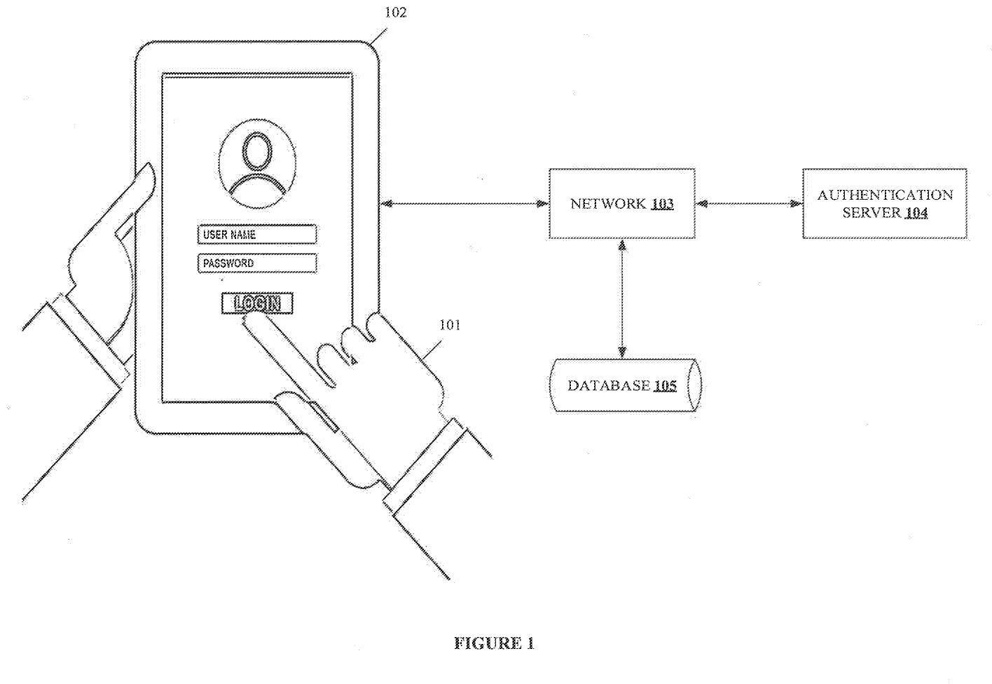

FIG. 1 shows an exemplary environment for detecting false authentication of a user from a device connected to a network, in accordance with some embodiments of the present disclosure.

In an embodiment, a user (101) using a device (102) may be connected to a network (103) for performing one or more tasks. The one or more tasks may include at least one of a file exchange, read from a file, write to or modify the contents of a file, interact with one or more equipment's (not shown in the Figure) for example, a server, a computer, a laptop, an Internet of Things (IoT) devices, a smart phone and the like, connected to the network (103). In an exemplary embodiment FIG. 1 may depict a scenario of an enterprise where employees of the enterprise connect to an enterprise network server via respective devices. The device (102) may include at least one of a computer, a laptop, a smartphone, an IoT device, a tablet computer and the like. The user (101) may login to at least one application among a plurality of applications in the device (102), by providing user credentials for example, username, password, fingerprint and the like. The device (102) upon validating the user (101) may allow the user (101) to perform one or more tasks using the at least one application. If the user (101) is not a valid user i.e. a false authentication is performed by the user (101), the network (103) and the one or more equipment connected to the network (103) may be corrupted for example, by introducing a malware into the network. To prevent the access to the network (103) by an invalid user, an authentication server (104) connected to the network (104) may be used to validate the user (101), while the user (101) is logging in to the at least one application in the device (102). The network (103) may include, for example, a direct interconnection, enterprise network, a Peer to Peer (P2P) network, Local Area Network (LAN), Wide Area Network (WAN), wireless network (e.g., using Wireless Application Protocol (WAP)), the Internet, Wireless Fidelity (Wi-Fi), cellular network, and the like. Further, the authentication server (104) may receive one or more parameters associated with the user (101). The one or more parameters may be captured by the device (102) while the user (101) is logging in to the at least one application and provide the one or more parameters to the authentication server (104). For example, biological credentials such as fingerprint may be captured using a fingerprint sensor configured in the device (102). In one embodiment, the authentication server (104) may host the at least one application and may be capable of capturing the one or more parameters. For example, username and passwords may be directly captured by the authentication server (104). The one or more parameters may include at least one of biometric details of the user (101), user credentials, and physical information of the user (101).

The authentication server (104) may generate a score by associating a binary value to the one or more parameters. The generated score may be indicative of a priority index associated with the user (101). For example, the priority index may be categorized as one of a normal user, a privileged user and an administrator user. The authentication server (104) may retrieve reference parameters of the user (101) from a database (105) based on the priority index. The reference parameters retrieved from the database (105) may be generated by a first Artificial Intelligence (AI) based learning algorithm using historic one or more parameters captured while the user (101) is interacting with the device (102), and may be sorted based on the generated score and stored in the database (105).

Furthermore, the authentication server (104) may compare the received one or more parameters with the reference parameters for validating the one or more parameters. The authentication server (104) may validate the one or more parameters by generating a modified score based on the comparison of the one or more parameters with the reference parameters and may determine one of a successful validation and an unsuccessful validation using the modified score and a second Artificial Intelligence (AI) based learning algorithm. Upon successful validation of the user (101), the authentication server (104) may allow the user (101) to access the at least one application in the device (102). Upon unsuccessful validation of the user (101), the authentication server (104) may provide one or more queries to the user (101). The one or more queries may be based on at least one of validation of the one or more parameters, the user details, the one or more Internet of Things (IoT) devices associated with the user (101), and a location of the user (101). The authentication server (104) may determine a false authentication of the user (101) based on a response received from the user (101) for the one or more queries. Further, the authentication server (104) may deny the user (101) access to the at least one application upon determining the false authentication of the user (101) and isolate the device (102) from the network (103) using techniques including at least one of containerization, virtualization or disabling a network adapter of the device (102). Thus, the authentication server (104) may protect the network (103) and the one or more equipment connected to the network (103) from corruption or failure.

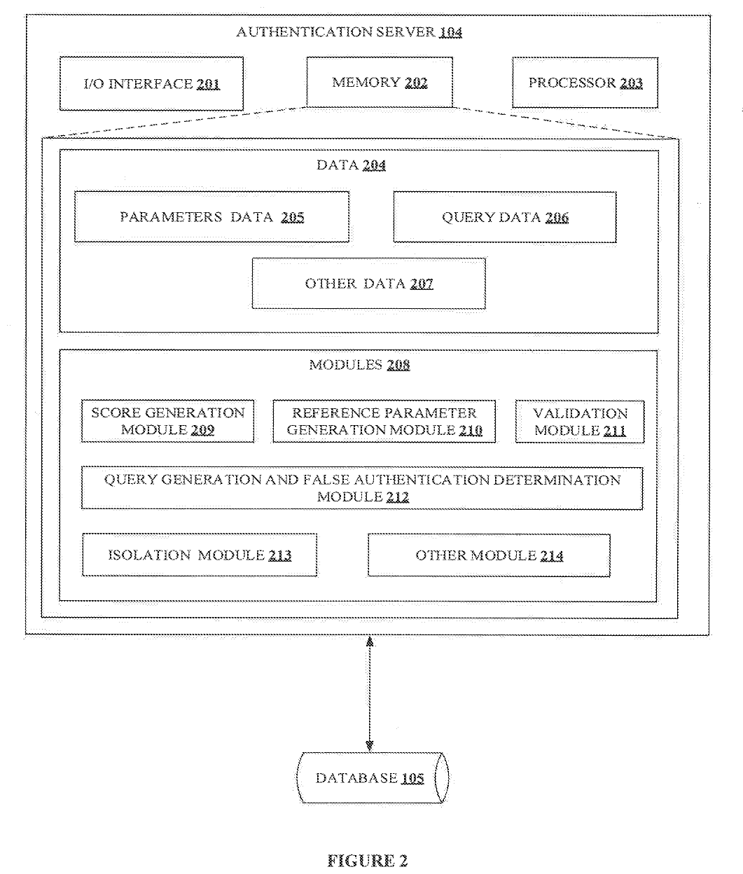

FIG. 2 shows a detailed block diagram of the authentication server (104), in accordance with some embodiments of the present disclosure.

The authentication server (104) may include a Central Processing Unit (“CPU” or “processor”) (203) and a memory (202) storing instructions executable by the processor (203). The processor (203) may include at least one data processor for executing program components for executing user or system-generated requests. The memory (202) may be communicatively coupled to the processor (203). The authentication server (104) further includes an Input/Output (I/O) interface (201). The I/O interface (201) may be coupled with the processor (203) through which an input signal or/and an output signal may be communicated. In one embodiment, the one or more parameters may be received through the I/O interface (201).

In some implementations, the authentication server (104) may include data (204) and modules (208). As an example, the data (204) and modules (208) may be present outside the memory (202) configured in the authentication server (104). In one embodiment, the data (204) may include, for example, parameters data (205), query data (206) and other data (207). In the illustrated FIG. 2, data (204) are described herein in detail.

In an embodiment, the parameters data (205) may include at least one of biometric details of the user (101), user credentials, and physical information of the user (101). The biometric details of the user (101) may include at least one of iris information, fingerprint information, face recognition information, retina information, voice information, palm vein information, and the like. The user credentials may include at least one of user identity, password, smart card, security key or digital signature, Rivest-Shamir-Adleman (RSA) identity token, and the like. The physical information of the user (101) may include at least one of hand type of the user (101) (for example, left handed or right handed), device (102) holding style (for example, the angle and the orientation at which the device (102) is held), heartbeat, body temperature, physical devices associated with the user (101)(for example, IoT enabled watches, activity trackers, pacemaker, wearable devices and the like). Further, the parameters data (205) may include a location of the user (101) captured using the device (102).

In an embodiment, the query data (206) may include the one or more queries required to be provided to the user (101), upon unsuccessful validation of the user (101). The one or more queries may be based on at least one of validation of the one or more parameters, the user details, the one or more Internet of Things (IoT) devices associated with the user (101), and the location of the user (101). The one or more queries may include at least one of requesting the user (101) information regarding date of birth, last four digits of the mobile number, favorite food, natural hand, administrator privileges, wearable devices, and the like.

In an embodiment, the other data (207) may include weights associated with the first and the second AI based learning algorithms, generated score based on the received one or more parameters, a desired response to the one or more queries stored in the query data (206) and the like.

In some embodiments, the data (204) may be stored in the memory (202) in form of various data structures. Additionally, the data (204) may be organized using data models, such as relational or hierarchical data models. The other data (207) may store data, including temporary data and temporary files, generated by the modules (208) for performing the various functions of the authentication server (104).

In some embodiments, the data (204) stored in the memory (202) may be processed by the modules (208) communicatively coupled to the processor (203) of the authentication server (104). The modules (208) may be stored within the memory (202). In one embodiment, the modules (208) may be stored in the memory (202) as shown in FIG. 2 and implemented as hardware. As used herein, the term modules (208) may refer to an Application Specific Integrated Circuit (ASIC), a FPGA (Field Programmable Gate Array), an electronic circuit, a processor (shared, dedicated, or group) that execute one or more software or firmware programs, a combinational logic circuit, and/or other suitable components that provide the described functionality.

In one implementation, the modules (208) may include, for example, a score generation module (209), a reference parameter generation module (210), a validation module (211), a query generation and false authentication determination module (212), an isolation module (213) and other module (214). It may be appreciated that such aforementioned modules (208) may be represented as a single module or a combination of different modules.

In an embodiment, the score generation module (209) may be used to generate a score by associating the binary value to the one or more parameters. Further, the binary value may be converted to at least one of a decimal value, hexadecimal value, an octal value and the like. The converted numeric value may be used to search and retrieve the reference parameters from the database (105). The generated score may be indicative of a priority index associated with the user (101). The score generation module (209) may associate the binary value “0” to a parameter from the one or more parameters if that parameter is not received and may associate the binary value “1” to a parameter from the one or more parameters that is received. The generated score may be used to determine the priority index associated with the user (101). For example, a priority index of “1” may be associated with the user (101) associated with a score in a range of 41 to 50 and categorized as a normal user. The score of 41 to 50 may indicate that the number of parameters for authenticating the user may be minimal. An administrator user may be associated with a score in a range of 60 to 70 which may indicate that a greater number of parameters may be considered for authenticating the admin user.

In an embodiment, the reference parameter generation module (210) may be used to generate the reference parameters using the first Artificial Intelligence (AI) based learning algorithm. The one or more parameters may be captured while the user (101) is interacting with the device (102) and received by the authentication server (104) periodically (for example, once in a day, every two hours and the like) or instantaneously (in real-time). For example, a voice sample of the user (101) may be captured every time the user (101) interacts with the device (102) and a reference pitch and the speed of utterance of words may be generated using the first Artificial Intelligence (AI) based learning algorithm (for example, logistic regression and the like).

In an embodiment, the validation module (211), may be used to compare the received one or more parameters with the reference parameters retrieved from the database (105). Further, the validation module (211) may be used for generating the modified the score based on the comparison. Furthermore, the validation module (211) may be used to determine one of the successful validation and the unsuccessful validation using the modified score and a second Artificial Intelligence (AI) based learning algorithm. For example, the second Artificial Intelligence (AI) based learning algorithm may be a supervised machine learning algorithm, such as K-Nearest Neighbor algorithm, Random Forests algorithm, and the like.

In an embodiment, the query generation and false authentication determination module (212) may be used to provide one or more queries to the user (101), upon unsuccessful validation of the user (101). The one or more queries may be selected from the query data (206) based on at least one of validation of the one or more parameters, the user details, the one or more Internet of Things (IoT) devices associated with the user (101), and the location of the user (101). For example, if the validation of the one or more parameters i.e. “hand type” was unsuccessful, then the one or more queries may be “What happened to your hand?”. In another example, the one or more queries may be “Do you have a pacemaker?”.

Further, the query generation and false authentication determination module (212) may be used to compare a response received from the user (101) for the provided one or more queries, with a desired response. If the received response and the desired response are matched, then the user (101) is allowed access to the at least one application. If the received response and the desired response do not match, then the false authentication of the user (101) is determined.

In an embodiment, the isolation module (213) may be used to deny access to the user (101) to the at least one application in the device (102), upon determining a false authentication of the user (101). The user (101) may be denied access to the at least one application by isolating the device (102) from the network (103) using at least one technique comprising at least one of containerization, virtualization or disabling a network adapter of the device (102).

In an embodiment, the other module (219) may be used to receive the one or more parameters from the device (102), retrieve the reference parameters from the database (105), store the generated reference parameters to the database (105), receive response to the one or more queries from the user (101) via the device (102) and the network (103).

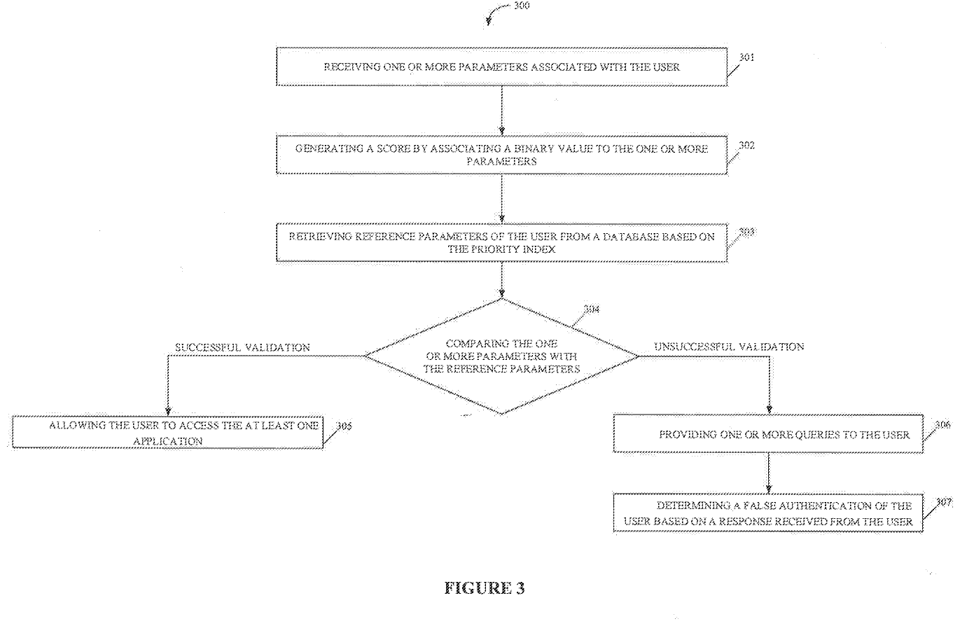

FIG. 3 shows a flowchart illustrating method steps for detecting false authentication of a user (101) from a device (102) connected to a network (103), in accordance with some embodiment of the present disclosure.

The order in which the method 300 may be described is not intended to be construed as a limitation, and any number of the described method blocks may be combined in any order to implement the method. Additionally, individual blocks may be deleted from the methods without departing from the scope of the subject matter described herein. Furthermore, the method may be implemented in any suitable hardware, software, firmware, or combination thereof.

At the step 301, the authentication server (104) may receive the one or more parameters associated with the user (101) while the user (101) is logging in to at least one application among the plurality of applications in the device (102) connected to the network (103). The one or more parameters may include at least one of biometric details of the user (101), user credentials, and physical information of the user (101).

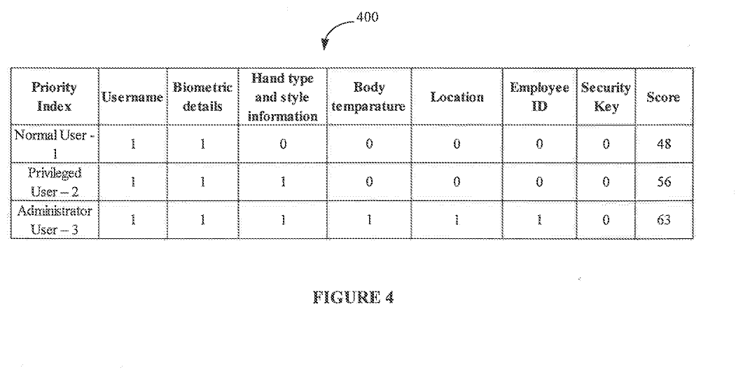

In an embodiment, the one or more parameters may be captured in real-time, while the user (101) is interacting with the device (102) or while the user (101) in logging in to at least one application with the device (102). The one or more parameters may include at least one of iris information, fingerprint information, face recognition information, retina information, voice information, palm vein information, user-identity, password, smart card, security key or digital signature, smart card of the user (101), Rivest-Shamir-Adleman (RSA) identity, hand type of the user (101) (for example, left handed or right handed), device (102) holding style (for example, the angle and the orientation at which the device (102) is held), heartbeat, location of the user (101), physical devices associated with the user (101) (for example, IoT enabled watches, activity trackers, pacemaker, wearable devices and the like) and the like as shown in table (400) of the FIG. 4.

At the step 302, the authentication server (104) may generate the score by associating the binary value to the one or more parameters. The generated score is indicative of the priority index associated with the user (101).

In an embodiment, authentication server (104) may associate the binary value of zero to each of the one or more parameters not received from the device (102) and may associate the binary value of one to each of the one or more parameters received from the device (102). Further, the binary value may be converted to at least one of a decimal value, hexadecimal value, an octal value and the like as shown in each row of table (400) in FIG. 4. For example, if location of the device (102) or the user (102) is received, then the binary value of one is assigned and if the hand type of the user (101) is not received, then the binary value of zero is assigned. Further, the binary value associated with the received and not received one or more parameters may be concatenated as “101001”, the corresponding score generated in terms of decimal value may be ‘41’. The generated score may be used to determine the priority index associated with the user (101). For example, the score having a value between 41 to 50 may be categorized as a normal user with a priority index of “1”, the score having a value between 51 to 60 may be categorized as a privileged user with a priority index of “2” and the score having a value between 61 to 70 may be categorized as an administrator user with a priority index of “3” as shown in table (400).

Referring back to FIG. 3, at the step 303, the authentication server (104) may retrieve the reference parameters of the user (101) from a database (105) based on the priority index. The reference parameters may be generated using the first Artificial Intelligence (A) based learning algorithms.

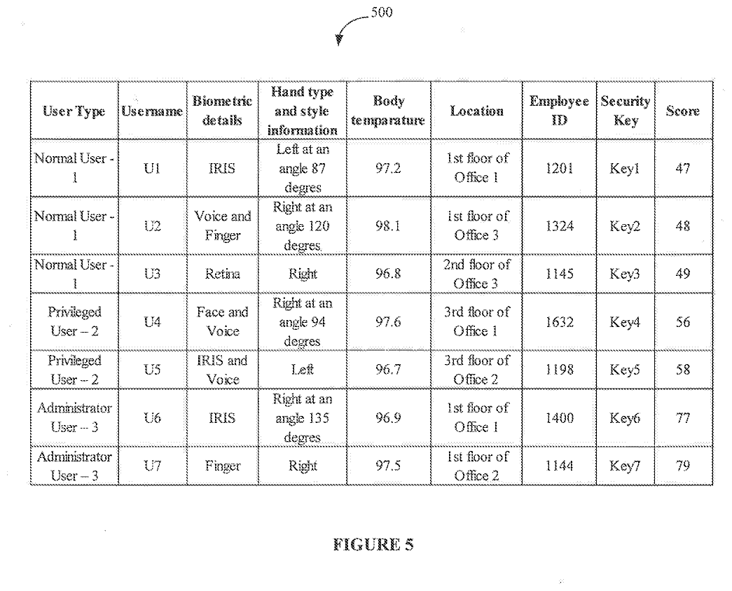

In an embodiment, the one or more parameters may be captured while the user (101) is interacting with the device (102) and received by the authentication server (104) periodically (for example, once in a day, every two hours and the like) or instantaneously (in real-time). Further, the first Artificial Intelligence (A) based learning algorithm may include at least one of the logistic regression, the clustering algorithm and the like. The first Artificial Intelligence (AI) based learning algorithm may use the one or more parameters captured while the user (101) is interacting with the device (102) to generate the reference parameters. For example, the user (101) body temperature may be captured every day during a first login of the user (101) and a clustering algorithm may provide the average body temperature of the user (101). The average body temperature of the user (101) may be the generated reference parameter corresponding to one of the one or more parameters i.e. “body temperature” as shown in table (500) of FIG. 5.

In an embodiment, the authentication server (104) may sort the reference parameters based on the generated score and store the reference parameters in the database (105) as shown in table (500). For example, a merge sort algorithm may be used for sorting the reference parameters based on the score. The reference parameters may be indicative of a threshold or a lower limit and an upper limit of the one or more parameters generated by the first AI based learning algorithm using the captured one or more parameters. For example, the speed of utterance of a word by the user (101) generated by the first AI based learning algorithm using the captured voice samples over a period of time, may be between 13 milliseconds to 15 milliseconds.

In an embodiment, the first Artificial Intelligence (AI) based learning algorithm may generate the reference parameters including a list of events the user (101) may perform based on the one or more parameters. For example, based on the location data, biometric data, hand position data, frequency of hand and finger movement data, captured over a period of time, the reference parameter may be generated as follows:

“User (101) at the location—A corresponding to the fingerprint-1 performs a punch into the office at 9:00 AM, logs in to the server—A at 9:10 AM”.

Referring back to FIG. 3, at the step 304, the authentication server (104) may compare the one or more parameters with the reference parameters for validating the one or more parameters. The authentication server (104) may validate the one or more parameters by generating a modified the score based on the comparison of the one or more parameters with the reference parameters and determining one of the successful validation and the unsuccessful validation using the modified score and a second Artificial Intelligence (AI) based learning algorithm.

In an embodiment, the authentication server (104) may compare the one or more parameters with the reference parameters by performing at least one of checking for equality, inequality, range check, type check and the like. The range check may include verifying the value of the one or more parameters to be within a specified lower and upper threshold of the reference parameter. For example, verifying if the pitch of the received voice signal is within 65 to 260 Hertz. The type check may include verifying the format (for example, number, alphabet, and biometric JPEG image and the like) of the one or more parameters to be consistent with the format of the reference parameters. For example, checking if the security key of the user (101) contains only numbers.

In an embodiment, the authentication server (104) may generate the modified score based on the result of comparison. If value of the received one or more parameters do not match with the reference parameters, then the binary value of one in the generated score may be modified and set to the binary value zero. For example, the binary value associated with the one or more parameters may be “101001” and the corresponding decimal value is 41. Based on the comparison if the location of the device (102) in the received one or more parameters and the reference parameters fail to match or validate, then the binary value associated with the one or more parameters i.e. location may be set to zero to obtain the modified score as “100001” and the corresponding score in terms of decimal value may be ‘33’.

In an embodiment, the modified score may be fed to the second Artificial Intelligence (AI) based learning algorithm to determine one of the successful or unsuccessful validation of the user (101). For example, the second Artificial Intelligence (AI) based learning algorithm may be a supervised machine learning algorithm (K Nearest Neighbor algorithm, Random Forests algorithm and the like).

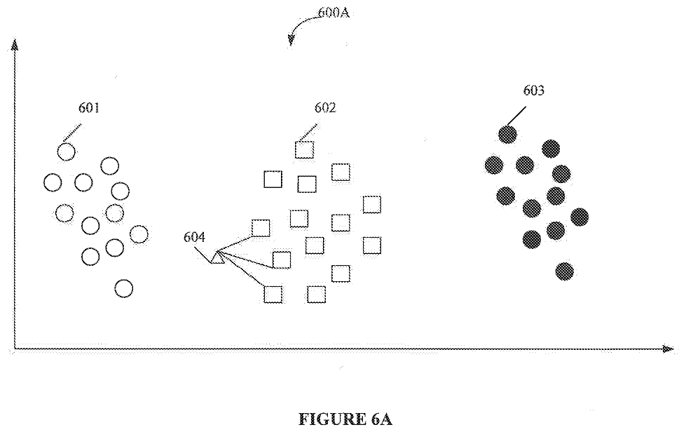

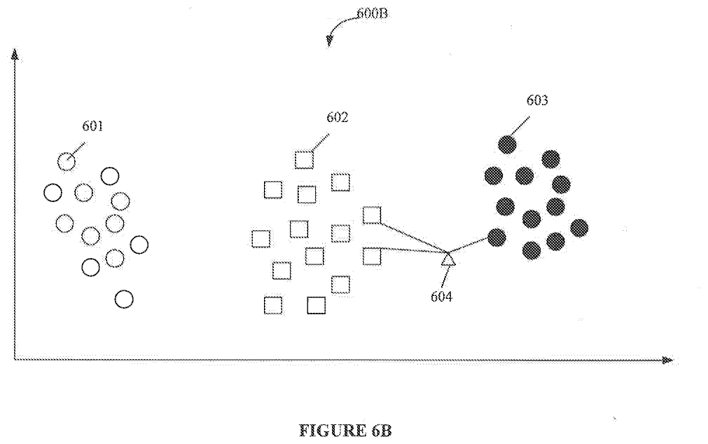

As shown in graph (600A) of FIG. 6A and graph (600B) of FIG. 6B, data points represented as white circles (601) without a filling may indicate a reference score generated from the reference parameters stored in the database (105) of the “Normal user” corresponding to the priority index of one. The data points represented as square boxes (602) may indicate the reference score of the “Privileged user” corresponding to the priority index of two. The data points represented as dark circles (603) with a black filling may indicate the reference score of the “Administrator user” corresponding to the priority index of three. The data point represented as a triangle (604) may indicate the modified score and fed to the second A based learning algorithm for example K-Nearest Neighbors (KNN).

Further, the KNN algorithm may be trained using the reference score generated from the reference parameters stored in the database (105) to obtain the various data points. For the fed data point (i.e. modified score represented by the triangle) depending on the value of “K” predetermined in the KNN algorithm for example as “3”, the distance between modified score and each of the other data points may be determined using the techniques for example, Euclidean distance, Manhattan distance, Hamming distance and the like. The KNN sorts all the data points in the ascending order based on the determined distance and chooses the first “K” data points from the sorted data points. The KNN, categorizes the fed modified score into one of the categories, i.e. “Normal user”, “Privileged User” or “Administrator user” based on the most frequently occurring category among the chosen “K” data points. If the category of the modified score and the generated score are same, the user (101) is validated as successful user else the user (101) is not validated and represented as unsuccessful user. As shown in the graph (600A), the modified score is categorized as “Privileged user” with the priority index of two. If the generated score corresponding to the modified score belonged to the category of “Privileged user” with the priority index of two, then the user (101) is validated as successful user else represented as unsuccessful user.

As shown in the graph (600B), let the data point represented as triangle indicate the modified score and the corresponding generated score belongs to the “Administrator user” with the priority index of three. The KNN algorithm categorizes the modified score as “Privileged user” with the priority index of two as shown in the graph (600B). Therefore, the user (101) may not be validated and represented as unsuccessful user.

Referring back to FIG. 3, at the step 305, upon successful validation of the user (101), the authentication server (104) may allow the user (101) to access the at least one application. The user (101) using the at least one application in the device (102) may communicate with the one or more equipment connected to the network (103) for performing the one or more tasks.

At the step 306, upon unsuccessful validation of the user (101), the authentication server (104) provides the one or more queries to the user (101). The one or more queries may be provided based on at least one of user details, one or more Internet of Things (IoT) devices associated with the user (101), and a location of the user (101). The one or more queries may be generated using techniques like natural language generation by the authentication server (104) or predetermined and stored in the authentication server (104).

In an embodiment, the one or more queries may include at least one of requesting the user (101) information regarding date of birth, last four digits of the mobile number, favorite food, natural hand, administrator privileges, wearable devices, and the like. For example, upon detecting a punch in time of a user (101) not in the range of a punch in time generated by the reference parameters. The user (101) may be validated as unsuccessful user and the one or more queries may be provided to the user (101) as “How come you are early to office today?”. The authentication server (104) may send the one or more queries to the user (101) via the network (103) and the device (102). The one or more queries may be provided to the user using at least one of a display unit associated with the device (102), a speaker associated with the device (102) and the like. The user (101) may respond to the one or more queries using the device (102). Further, the device (102) may forward the response to the authentication server (104) via the network (103). For example, the user (101) may respond to one or more queries as “1 have a meeting” via a voice command or through a keypad associated with the device (102).

At the step 307, the authentication server (104) determines the false authentication of the user (101) based on a response received from the user (101) for the one or more queries. Further, the user (101) is denied access to the at least one application by isolating the device (102) from the network (103) using techniques comprising at least one of containerization, virtualization or disabling a network adapter of the device (102).

In an embodiment, the authentication server (104) may compare the response received from the user (101) to the one or more queries with the desired response. The desired response may be stored in the authentication server (104) or the database (105). If the received response and the desired response are equal, then the user (101) may be determined as a true authentication and the authentication server (104) allows the user (101) to access the at least one application. If the received response and the desired response are not equal, then the user (101) may be determined as the false authentication and the user (101) may be denied access to the at least one application. For example, if the received response is the date of birth of the user (101), the received response may be compared with the date of birth stored in the database (105) to determine one of the true authentication or the false authentication of the user (101).

In an embodiment, the containerization may be a process of using a docker based CPU, mount space, and the like to isolate the device (102) by switching off the CPU and setting the mount space value to zero. The virtualization may be a method whereby the device (102) hosting a virtual environment is isolated by turning off the virtual process running on the device (102). Further, the device (102) may be isolated from the network (103) by turning off Wi-Fi or disabling keying parameters, etc.

The authentication server (104) by isolating the device (102) from the network (103) may provide network security to the one or more equipment connected to the network (103). Further, the authentication server (104) by isolating the device (102) from the network (103) may prevent malware or virus infection to the one or more equipment connected to the network (103) by detecting the false authentication of the user (101).

### Computer System

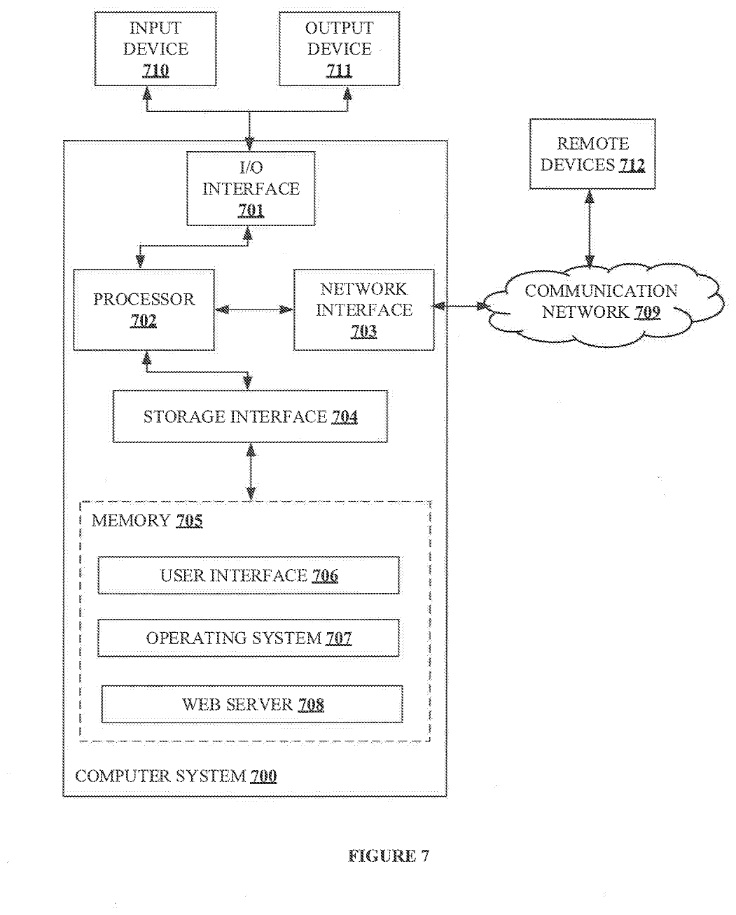

FIG. 7 illustrates a block diagram of an exemplary computer system (700) for implementing embodiments consistent with the present disclosure. In an embodiment, the computer system (700) may be used to implement the method for detecting false authentication of a user (101) from a device (102) connected to a network (103). The computer system (700) may comprise a central processing unit (“CPU” or “processor”) (702). The processor (702) may comprise at least one data processor for executing program components for dynamic resource allocation at run time. The processor (702) may include specialized processing units such as integrated system (bus) controllers, memory management control units, floating point units, graphics processing units, digital signal processing units, etc.

The processor (702) may be disposed in communication with one or more input/output (I/O) devices (not shown) via I/O interface (701). The I/O interface (701) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface (701), the computer system (700) may communicate with one or more I/O devices. For example, the input device (710) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device (711) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system (700) is connected to the service operator through a communication network (709). The processor (702) may be disposed in communication with the communication network (709) via a network interface (703). The network interface (703) may communicate with the communication network (709). The network interface (703) may employ connection protocols including, without limitation, direct connect, Ethernet (e.g., twisted pair 10/100/1000 Base 7), transmission control protocol/Internet protocol (TCP/IP), token ring, IEEE 802.11a/b/g/n/x, etc. The communication network (709) may include, without limitation, a direct interconnection, e-commerce network, a peer to peer (P2P) network, local area network (LAN), wide area network (WAN), wireless network (e.g., using Wireless Application Protocol), the Internet, Wi-Fi, etc. Using the network interface (703) and the communication network (709), the computer system (700) may communicate with the one or more service operators.

In some embodiments, the processor (702) may be disposed in communication with a memory (705) (e.g., RAM, ROM, etc. not shown in FIG. 7 via a storage interface (704). The storage interface (704) may connect to memory (705) including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (705) may store a collection of program or database components, including, without limitation, user interface (706), an operating system (707), web server (708) etc. In some embodiments, computer system (700) may store user/application data (706), such as the data, variables, records, etc. as described in this disclosure. Such databases may be implemented as fault-tolerant, relational, scalable, secure databases such as Oracle or Sybase.

The operating system (707) may facilitate resource management and operation of the computer system (700). Examples of operating systems include, without limitation, APPLE® MACINTOSH® OS X®, UNIX, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE IOS®, GOOGLE™ ANDROIDT™, BLACKBERRY® OS, or the like.

In some embodiments, the computer system (700) may implement a web browser (not shown in the Figure) stored program component. The web browser may be a hypertext viewing application, such as MICROSOFT® INTERNET EXPLORER®, GOOGLE™ CHROME™, MOZILLA® FIREFOX®, APPLE® SAFARI, etc. Secure web browsing may be provided using Secure Hypertext Transport Protocol (HTTPS), Secure Sockets Layer (SSL), Transport Layer Security (TLS), etc. Web browsers (708) may utilize facilities such as AJAX, HTML, ADOBE® FLASH®, JAVASCRIPT®, JAVA®, Application Programming Interfaces (APIs), etc. In some embodiments, the computer system (700) may implement a mail server stored program component not shown in the Figure). The mail server may be an Internet mail server such as Microsoft Exchange, or the like. The mail server may utilize facilities such as Active Server Pages (ASP), ACTIVEX®, ANSC® C++/C#, MICROSOFT®, .NET, CGI SCRIPTS, JAVA®, JAVASCRIPT®, PERL®, PHP, PYTHON®, WEBOBJECTS®, etc.

The mail server may utilize communication protocols such as Internet Message Access Protocol (IMAP), Messaging Application Programming Interface (MAPI), MICROSOFT® Exchange, Post Office Protocol (POP), Simple Mail Transfer Protocol (SMTP), or the like. In some embodiments, the computer system (700) may implement a mail client stored program component not shown in the Figure). The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processors to perform steps or stages consistent with the embodiments described herein. The term “computer-readable medium” should be understood to include tangible items and exclude carrier waves and transient signals, i.e., non-transitory. Examples include Random Access memory (RAM), Read-Only memory (ROM), volatile memory, non-volatile memory, hard drives, Compact Disc (CD) ROMs, Digital Video Disc (DVDs), flash drives, disks, and any other known physical storage media.

In some implementation the one or more parameters, the response to the one or more queries may be received from the remote devices (712). In an embodiment, the remote devices (712) may be the device (102).

The method of detecting false authentication of a user (101) from a device (102) connected to a network (103) provides two factor authentication and improves the security of the device (101) and the network (103) using a multi-level of security processing. Further, the internal device (101) failures may be addressed more efficiently. Furthermore, isolating the infected device (101) prevents the issue from spreading across to one or more equipment in the network (103).

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it may be readily apparent that more than one device/article (whether or not they cooperate) may be used in place of a single device/article. Similarly, where more than one device or article is described herein (whether or not they cooperate), it may be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments may be apparent to those skilled in the art. The various aspects and embodiments disclosed herein are for purposes of illustration and are not intended to be limiting, with the true scope being indicated by the following claims.

What is claimed is:

1. A method of detecting false authentication of a user from a device connected to a network, the method comprising:
receiving, by an authentication server, one or more parameters associated with the user while the user is logging in to at least one application among a plurality of applications in the device connected to the network;
generating, by the authentication server, a score by associating a binary value to the one or more parameters, wherein the score is indicative of a priority index associated with the user;
retrieving, by the authentication server, reference parameters of the user from a database based on the priority index;
comparing, by the authentication server, the one or more parameters with the reference parameters for validating the one or more parameters; and
allowing, by the authentication server, the user to access the at least one application upon successful validation; or
performing, by the authentication server, upon unsuccessful validation,
providing one or more queries to the user; and
determining a false authentication of the user based on a response received from the user for the one or more queries, wherein the user is denied access to the at least one application.

2. The method of claim 1, wherein the one or more parameters comprises at least one of biometric details of the user, user credentials, and physical information of the user.

3. The method of claim 1, wherein the reference parameters are generated by a first Artificial Intelligence (A) based learning algorithm using the one or more parameters captured while the user is interacting with the device.

4. The method of claim 1, wherein validating the one or more parameters comprises:
generating a modified the score based on the comparison of the one or more parameters with the reference parameters; and
determining one of the successful validation and the unsuccessful validation using the modified score and a second Artificial Intelligence (AI) based learning algorithm.

5. The method of claim 1, wherein providing the one or more queries is based on at least one of validation of the one or more parameters, user details, one or more Internet of Things (IoT) devices associated with the user, and a location of the user.

6. The method of claim 1, wherein the user is denied access to the at least one application by isolating the device from the network using techniques comprising at least one of containerization, virtualization, or disabling a network adapter of the device.

7. An authentication server, for detecting false authentication of a user from a device connected to a network, the authentication server comprises:
a processor; and
a memory communicatively coupled to the processor, wherein the memory stores the processor executable instructions, which, on execution, causes the processor to:
receive one or more parameters associated with the user while the user is logging in to at least one application among a plurality of applications in the device connected to the network;
generate a score by associating a binary value to the one or more parameters, wherein the score is indicative of a priority index associated with the user;
retrieve reference parameters of the user from a database based on the priority index;
compare the one or more parameters with the reference parameters for validating the one or more parameters; and
allow the user to access the at least one application upon successful validation; or
perform upon unsuccessful validation,
provide one or more queries to the user; and
determine a false authentication of the user based on a response received from the user for the one or more queries, wherein the user is denied access to the at least one application.

8. The authentication server of claim 7, wherein the processor is configured to receive the one or more parameters comprising at least one of biometric details of the user, user credentials, and physical information of the user.

9. The authentication server of claim 7, wherein the processor is configured to generate the reference parameters using a first Artificial Intelligence (AI) based learning algorithm based on the one or more parameters captured while the user is interacting with the device.

10. The authentication server of claim 7, wherein the processor is configured to validate the one or more parameters comprises:
generating a modified the score based on the comparison of the one or more parameters with the reference parameters; and
determining one of the successful validation and the unsuccessful validation using the modified score and a second Artificial Intelligence (AI) based learning algorithm.

11. The authentication server of claim 6, wherein the processor is configured to provide the one or more queries based on at least one of validation of the one or more parameters, user details, one or more Internet of Things (IoT) devices associated with the user, and a location of the user.

12. The authentication server of claim 6, wherein the processor is configured to deny the user, access to the at least one application by isolating the device from the network using techniques comprising at least one of containerization, virtualization, or disabling a network adapter of the device.

13. A non-transitory computer readable medium including instructions stored thereon that when processed by at least one processor cause a device to perform operations comprising:
receiving, by an authentication server, one or more parameters associated with the user while the user is logging in to at least one application among a plurality of applications in the device connected to the network;
generating, by the authentication server, a score by associating a binary value to the one or more parameters, wherein the score is indicative of a priority index associated with the user;
retrieving, by the authentication server, reference parameters of the user from a database based on the priority index;
comparing, by the authentication server, the one or more parameters with the reference parameters for validating the one or more parameters; and
allowing, by the authentication server, the user to access the at least one application upon successful validation; or
performing, by the authentication server, upon unsuccessful validation,
providing one or more queries to the user; and
determining a false authentication of the user based on a response received from the user for the one or more queries, wherein the user is denied access to the at least one application.

14. The media of claim 13, wherein the instructions causes the processor to receive the one or more parameters comprising at least one of biometric details of the user, user credentials, and physical information of the user.

15. The media of claim 13, wherein the instructions causes the processor to generate the reference parameters using a first Artificial Intelligence (AI) based learning algorithm based on the one or more parameters captured while the user is interacting with the device.

16. The media of claim 13, wherein the instructions causes the processor to validate the one or more parameters comprises:
generating a modified the score based on the comparison of the one or more parameters with the reference parameters; and
determining one of the successful validation and the unsuccessful validation using the modified score and a second Artificial Intelligence (AI) based learning algorithm.

17. The media of claim 13, wherein the instructions causes the processor to provide the one or more queries based on at least one of validation of the one or more parameters, user details, one or more Internet of Things (IoT) devices associated with the user, and a location of the user.

18. The media of claim 13, wherein the instructions causes the processor to deny the user, access to the at least one application by isolating the device from the network using techniques comprising at least one of containerization, virtualization, or disabling a network adapter of the device.
